(19) United States
(12) Patent Application Publication
(10) Pub. No.: US 2008/0140495 A1
(43) Pub. Date: Jun. 12, 2008

(54) SYSTEM AND METHOD FOR RESILIENCY PLANNING

(76) Inventors: Anuradha Bhamidipaty, Bangalore (IN); Rohit M. Lotlikar, Bangalore (IN); Guruduth Somasekhara Banavar, Pelham Manor, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/609,599

(22) Filed: Dec. 12, 2006

(51) Int. Cl. G06Q 10/00

(52) U.S. Cl. 705/9; 705/8

(57) ABSTRACT

A method and a system for efficiently planning resiliency in a work environment based on resiliency parameters for a given definition of service, determining a best allocation plan with resources allocated, and allocating a resource request in a best allocation plan to the requesting source to perform the definition of service.

### FIELD OF THE INVENTION

This invention relates to a method and system for resiliency planning. More particularly, this invention relates to a method and system for skill resiliency planning for efficient business resiliency planning.

### BACKGROUND OF THE INVENTION

The failure to plan for uncertainty can be disastrous for an organization. The objective of traditional business continuity planning is to restore operations and supporting infrastructure after an interruption. Business resilience planning gives a company the ability to weather a disruptive incident without major interruptions to service delivery. A business can maintain continued customer service, safeguard employees and assets, protect its brands and ultimately minimize losses. Properly executed, business resilience planning can actually reduce a company's business risk. By better understanding risks, alternative strategies can be developed to cope with these incidents. Often, opportunities and cost savings can also be identified.

The process of business resiliency planning begins with the identification and analysis of all significant threats, vulnerabilities and inter-dependencies related to critical business functions throughout the organization, at both the functional and the geographic levels. Most companies associate a business disaster with events such as a fire, explosion or power outage. However, in today's integrated world, threats to business also include disruptions to key outsourced business functions and critical suppliers who are suddenly unable to deliver a product or service on time. The inability to meet peaks in customer demand or loss of important employees and key customers are potential and serious business risks that must be considered.

Once all significant risks have been identified, overall business resilience capability is assessed. The effectiveness of existing disaster recovery, business continuity and crisis management plans throughout the organization are then evaluated. With this background information, gaps or vulnerabilities can be identified for critical business functions and operational infrastructures and compared against specific risks. The potential business impact for each is then measured so that alternative, cost-effective solutions can be put into place, if necessary.

Documentation of policies, procedures, education and routine testing are important ingredients to successful business resiliency plans. However, in our ever-changing business environment, strong maintenance programs are required to ensure that resiliency plans are kept current and monitored on an ongoing basis. Managing various forms of risk is critical to the bottom line. Robust business resiliency planning can protect and improve a company's customer service, brand reputation, people and profits.

For efficient business resiliency planning, skills resiliency is an important ingredient, which is difficult to plan and is often overlooked. Without prior planning in place, skills unavailability is more difficult to address and more expensive to address, especially in disruptions. A disadvantage is that over time work may become unequally distributed across available resources, especially in the service delivery domain Importantly, in the service delivery domain, the constraints associated with resiliency planning are very unique.

Without a way to improve the method and system of skill resiliency planning, the promise of this technology may never be fully achieved.

### SUMMARY OF THE INVENTION

A first aspect of the invention is a method for skill resiliency planning for efficiently generating an allocation plan for a given request, the request containing the definition of services. A request containing the definition of services, also referred to as a statement of work, is received. At least one allocation plan is created based on the available resources, the resiliency options and the received request. From the at least one allocation plans that have been crated, the most optimal allocation plan is identified, and the most optimal allocation plan is assigned to the requesting entity. An advantage is that the most optimal allocation plan identified accomplishes the definition of services requested in an efficient manner, by saving time, costs and other identified business risks.

A second aspect of the invention is a system for efficiently planning skills resiliency for a given request and generating at least one allocation plan based on the available resources, the resiliency options and the received request. Each of the at least one allocation plans is tested and the most optimal allocation plan is identified and assigned for completing the request. The most optimal allocation plan accomplishes the definition of services efficiently and optimally.

A third aspect of the invention is a electronic device which contains at least a memory, a processor and the system as described previously, which is configured to efficiently plan skill resiliency and generate the most optimal allocation plan to complete the definition of services as discussed previously.

### BRIEF DESCRIPTION OF THE DRAWINGS

FIG. 1 illustrates an exemplary embodiment of a resiliency planning system in accordance with the invention.

FIG. 2 illustrates an exemplary embodiment of hoarding workflow for a receiving entity and a servicing entity.

FIG. 3 illustrates an exemplary embodiment of a computer system suitable for use with the method of FIG. 2 and in the architecture of FIG. 1.

### DETAILED DESCRIPTION

### Overview

Where reference is made in any one or more of the accompanying drawings to steps and/or features, which have the same reference numerals, those steps and/or features have for the purposes of this description the same function(s) or operation(s), unless the contrary intention appears. The expression “requesting entity” should be understood as a client. The expression “request” should be understood as a “definition of services” (DOS) or “statement of work” (SOW) Other equivalent expressions to the above expression would be apparent to a person skilled in the art.

Clients preferably include and are not limited to a variety of portable electronic devices such as mobile phones, personal digital assistants (PDAs), pocket personal computers, laptop computers, application servers, web servers, database servers and the like. It should be apparent to a person skilled in the art that any electronic device which includes at least a processor and a memory can be termed as a client within the scope of the present invention.

Disclosed is a system and method for skill resiliency planning which is advantageously used in business planning resiliency. Efficient skill resiliency planning improves business resiliency and business productivity. The skill resiliency planning involves identifying an optimal resource and/or an optimal set of resources for a request, which can accomplish the definition of services (DOS) and form an optimal allocation plan. When assigned and executed, the optimal allocation plan can save time and costs, and overcomes other identified business risks.

### Resiliency Planning System

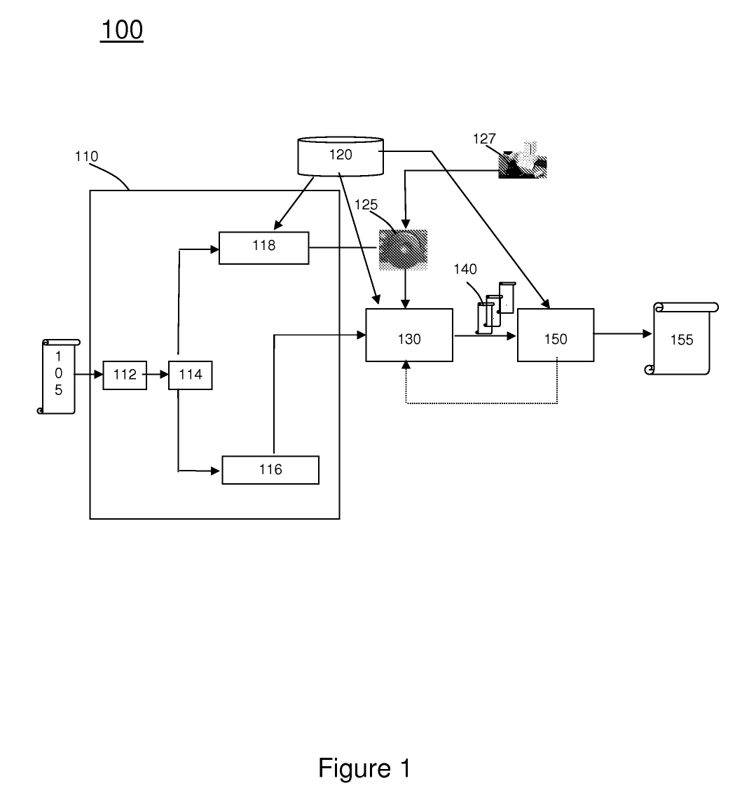

FIG. 1 illustrates an exemplary embodiment of a resiliency planning system 100. The resiliency planning system 100 is configured to receive the DOS 105 as input from a client (not shown in the Figure). The DOS 105 is typically a critical ingredient of a successful procurement of services in the development and documentation of the requirements in skill resiliency planning. Typically, the DOS identifies what the contractor or service provider has to accomplish, by first identifying the primary objectives and then the subordinate objectives. One of the goals of the DOS is to gain understanding and agreement between the client and the service provider about the specific nature of the technical activity to be performed. In other words, the DOS is a formal contract document or agreement that is signed by the client and the service provider, which states at least the minimum scope of work, deliverables, commercial details and terms and conditions. The DOS also specifies the typical SLA requirements (e.g., quality expectations, resource description, reward-penalty clauses, etc.).

The system includes a controller 110 which includes a receiving means 112, analyzing means 114, a skill mapping means 116 and a workload analyzing means 118. The receiving means 112 is configured to receive the DOS 105 from the client. As stated earlier the DOS 105 contains a number of parameters and conditions associated with the activity requested in the DOS 105. After being received at the receiving means 112 the DOS 105 is then transmitted to an analyzing means 114. The analyzing means 114 is configured to analyze the various parameters and conditions in the DOS 105. Moreover, the analyzing means 114 determines what actions (e.g., tasks, services, processes, etc.) are to be performed by the client. The analyzing means 114 can be a fully automated process, semi-automated process, and/or manual process.

The analyzing means 114 is coupled to a workload analyzing means 118 and to a skill mapping means 116. The skill mapping means 116 outputs the skills set required to perform the detailed set of tasks that have been identified in the DOS 105. The skills set consists of resources, which are typically human resources. Further details associated with the skills can be provided (e.g., expertise required, percentage usage of each skill used, etc.). The workload analyzing means 118 is configured to determine several parameters (e.g., critical versus non critical services, percentage of workload, etc.). The workload analyzing means 118 also addresses and determines the values for resiliency parameters (e.g., deliverables, resource descriptions, SLA requirements, quality expectations, etc.). The resiliency parameters vary for each DOS 105 and for a given listing of tasks included in a DOS 105. The resiliency parameters may be derived from a repository, such as a repository of historical information and/or a repository of domain rule sets. On the other hand, the workload analyzing means 118 may utilize the tasks included in the DOS 105 to dynamically compute the resiliency parameters. The resiliency parameters can optionally be tuned via a tuning means 125, by a user 127. They user can tune the resiliency parameter such that they reflect the correct business resiliency requirements of the client, when operated manually by the user 127. The analyzing means 114 is coupled to a skill mapping means 116, which is configured to outputs the skills set required, and to map the available resource with the required skill set.

The combination of the tasks identified with the resiliency parameters and the available resources associated with the required skill set are transmitted to an allocating means 130. The identified tasks may or may not be tuned. The allocation means 130 is configured to create at least one allocation plan based on the task identified in the DOS 105, the resiliency parameters and the available resources. The allocating means 130 is also interfaced with a database 120, which can provide the allocating means 130 with several different types of data (e.g., past outages, skills availability, baseline resiliency, etc.). The allocating means is configured to feed the at least one allocation plan 140 to an output means 150. The output means 150 is configured to test each of the at least one allocation plans 140 and determine the most optimal allocation plan 155, which is then assigned to the client. In one embodiment, the output means 150 is also interfaced with the database 120 such that the output means 150 can use parameters such as past outages and the likes to identify the most optimal allocation plan 140. The output means 150 and the allocating means 130 are interfaced such that each of the allocation plans that are tested, may be sent back to the allocating means 130 to be refined further and then tested again in the output means 150 iteratively.

The client is coupled to the resiliency planning system 100 by means of a wired network, a wireless network or a combination thereof. For example a wired network includes coupling via cable, optical fiber and the like. Wireless networks include wireless standard such as Bluetooth, digitally enhanced cordless telecommunication (DECT), dedicated short range communication (DSRC), HIPERLAN, HIPERMAN, IEEE 802.11x, IRDA, Radio frequency Identification (RFID), WiFi, WiMax, xMax, ZigBee and the like. In one embodiment, the client is configured to create the DOS 105 based on the requirements at the client, and then transmit the DOS 105 to the resiliency planning system 100. The client is configured to initiate transmitting the DOS 105 to the resiliency planning system 100 using push mechanism. The resiliency planning system 100 is then configured to receive the request from the client, analyze the DOS 105, generate at least one or more allocation plans and select the most optimal allocation plan for performing the DOS 105. An advantage of this method is better predictability, efficient performance and cost savings.

### Workload Analyzing Means

Reference is now made to FIG. 1, wherein the workload analyzing means 118 is configured to determine a plurality of resiliency parameters and the values of the resiliency parameters, depending on the tasks provided by the analyzing means 112. These resiliency parameters determine the critical tasks that cannot be bypassed and also have a relatively short timeframe for completion. The workload analyzing means 118 interfaces with a repository 120 consisting of a knowledge base representing historical information.

The historical information in the repository can determine the importance of a service and/or if a step in a process or the end-to-end process is critical. The repository 120 is additionally configured to store rules defined by a domain expert. An example of a rule can be “Security service is critical and should be available at all times” or “70% of the command center operations for every contract should be included for resiliency support.”

The repository 120 of historical information can also utilize trend analysis to determine the percentage of critical workload for a service. For example, depending on past outages it could indicate that “80% of Sev2 tickets in Windows Patch Management are critical.” The workload analyzing means 118 also considers the quality of service parameters mentioned in the service level agreements of the DOS 105 to determine the criticality of a task. The resiliency parameters and their values determined by the workload analyzer means can be optionally be tuned by the user to correctly reflect the customer resiliency needs. The user can augment the output with values for additional parameters.

### Skills Mapping Means

A skills mapping means 116 component performs the mapping of a given set of tasks output by a analyzing means (contract analyzer) 112 to a corresponding set of skills required to perform the tasks. The output is at a granularity level that is understood by the allocation engine 130. An example output could be the number of resources required for each skill, their expertise level and the percentage of usage for each resource.

### Allocating Means

This component interfaces with a number of other components to determine an intelligent skill allocation plan to satisfy the customer desired resiliency requirements.
a. Resiliency parameters and their values specified by the workload analyzing means 118.
b. Skill set requirements as listed by the skills mapping means.
c. A repository representing the global skills footprint—that is, skill availability information at each location.
d. Baseline resiliency—this data represents the built-in resiliency in the organization for human resources. For example, if 30% of the resources are “more” available than the others as they have laptop computers and home broadband connection, the allocation plan should provide for resiliency over and above this baseline as indicated by the customer.

### The allocating means outputs a skill allocation plan for meeting the desired resiliency requirements.

### Output Means

The allocation plan is fed into the output means 150 component to verify it against a defined set of outage scenarios. These scenarios can be chosen by the user or determined by the system based on past outage data. There is a feedback loop from the output means 150 to the allocating means to determine the re-allocation of skills if the plan does not work for a particular outage. The output means 150 is then configured to generate an final plan 155 based on the various input parameters and the resiliency associated with each of the input parameters.

In one embodiment, the user can specify the outage scenarios and the desired performance against them as parameters to the workload analyzing means. The workload analyzing means 118 then determines the critical tasks that need to be made available to satisfy the customer needs. In a further embodiment, the output of the allocation means 130 can be tuned by a user to satisfy the specific outage scenarios.

### Workflow for Skill Resiliency Planning

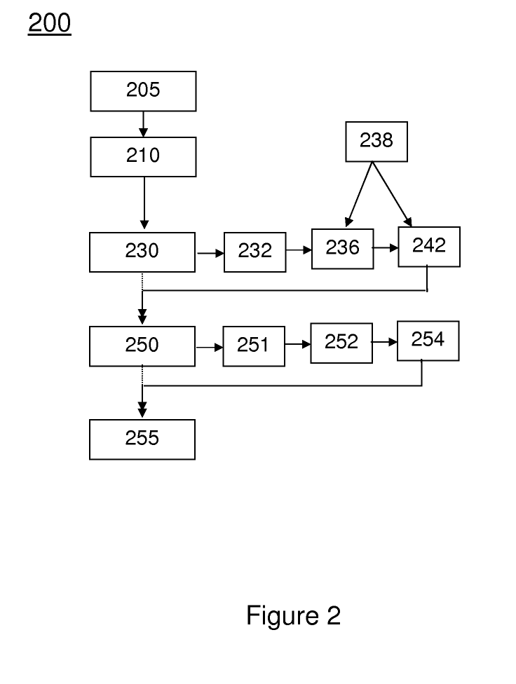

FIG. 2 illustrates an exemplary embodiment of a method of skill resiliency planning 200. The method for skill resiliency planning requires an input in the form of a request 205, i.e. the DOS, from the client. In 210, the method includes receiving the DOS 205 from the client at the resiliency planning system 100. After receiving the request in 230 the workflow involves creating at least one allocation plan based on the available resources, the resiliency parameters and the tasks identified in the DOS. A typical allocation plan includes at least the tasks identified in the DOS which are mapped to a resource having the relevant skill set to perform the task; where the tasks identified will be performed efficiently and optimally by the resource. The allocation plan can include other parameters as well (e.g., defining granularity of the work, risks involved, etc.). After the allocation plans have been created in 250, the method involves testing the allocation plans that have been created and identifying an optimal allocation plan from the available allocation plans.

After receiving the DOS in 210 an allocation plan is created in 230. The method of creating includes analyzing the DOS in 232 for the components requested (e.g., the tasks, the resources, etc.). The DOS contains a number of parameters and conditions associated with the requested activity in the DOS. In 232, the DOS is analyzed for the various parameters and conditions to determine the set of tasks, services, processes, etc., requested. This process may be a fully automated process, semi-automated process, or a manual process. The manual process is most familiar in the domain of service delivery. After the DOS has been analyzed in 236, a work schedule is created of tasks that are identified from the DOS. In creating the work schedule and categorizing the identified tasks, the tasks can be categorized into different categories based on the resiliency parameters (e.g., critical, vital, sensitive, non-critical, etc.). Creating the work schedule is interfaced in 238 with a database consisting of resiliency parameters to categorize the identified tasks. After the tasks have been identified, in 242 available resources are identified by interfacing with a repository 238. Then, the available resources having the relevant skill set are identified and mapped to the tasks identified in the work schedule.

In 250 the allocation plans are prepared and tested, and an optimal allocation plan is identified from the group is identified. In 251, the allocation plans prepared in 250 are input to an output means. In 252, the allocation plans that have been prepared are compared against problems (e.g., past outages, etc.) in a repository 238. In 254, a final optimal allocation plan is identified which takes into account all the resiliency parameters that have been identified. In 255, the optimal allocation plan is output. The optimal allocation plan can be assigned to the requesting entity and to the allocated resources.

### Outline of the Algorithm

The algorithm is defined by the following parameters

Input:
Skill requirements for performing the services
Critical tasks in each service
Databases: skills availability, base line resiliency, etc.

Output:
Allocation plans
Optimal allocation plan

The main steps of the algorithm include:
1. For each service,
   a. Quantify the critical workload that needs to be considered for resiliency planning by skills allocation:
      Quantify the workload corresponding to the critical tasks
      Quantify the workload that can be supported by the baseline resiliency provided at a location
      Compute the difference of the two to obtain the desired critical workload
   b. Identify the skills requirements for satisfying the critical workload computed in step (a). This is the minimum set of skills that need to be distributed for resiliency
2. Identify two or more service delivery locations which together satisfy the skills requirements as computed in step (b) for multiple services and output allocation plan(s).

The variations that are considered in the algorithm include:
1. Skills can be specified in a variety of ways, for example:
   a. A resource can have only one skill and be an expert or non-expert in that skill.
   b. A resource can have one primary and multiple secondary skills.
In the above case, the allocating means should compute the skills allocation plan based on a minimal set of resources to be distributed, considering the fact the people with multiple skills can use their secondary skills to meet critical workload requirements as well.
   c. A resource typically works dedicated for a contract. However, in cases of disruption, if required, the resource can switch to work part or full-time to provide the same service for other contracts.
In this case, the allocating means should compute the skill allocation plan based on a minimal set of resources to be distributed, considering the sharing of resources across multiple contracts.
2. Quantification of the critical workload can be done in multiple ways, for example:
   a. Calculated as percentage of tickets in the service
   b. Calculated as percentage of man-hours required to perform the service
3. Allocating means can consider cost structure of multiple service delivery locations to prioritize plans based on cost.
4. Allocating means can consider the entire set of delivery locations or user can specify the subset of locations for the engine to choose from.

### EXAMPLE

Consider a DOS/SOW with two services and the processes followed in each of the services is:
1. UNIX/AIX Server System Administration (200 servers)—Change/Incident/Problem management
2. Storage Management (100 ESS boxes)—Change/Problem management
   The skill requirements for these services as output by the skill mapping means are as follows:
1. UNIX/AIX—6 resources—4 of normal expertise and 2 experts
2. Storage admins—4 resources—2 of normal expertise and 2 experts

### All resources are utilized at 100%. An expert resource can handle critical workload at 100% utilization unlike a normal resource.

The output of the workload analyzing means is as follows:
1. UNIX/AIX administration
   a. Patch installation process is critical—constitutes 20% of the total number of tickets
   b. 70% of sev1 and 50% of sev2 tickets are critical
   c. Distribution of the tickets—40% are Sev1, 30% are Sev2 and 30% remaining
   d. Expert resource works 70% of time on Sev1 and 20% on Sev2; Normal resource works 60% on Sev2 and 20% on Sev2.
2. Storage administration
   a. 80% of sev1 are critical
   b. Distribution of the tickets—50% are Sev1, 30% are Sev2 and 20% remaining
   c. Expert resource works 50% of time on Sev1 and normal resource works 30% of time on Sev1

Consider three distributed locations from where the service delivery operations could be performed. The following indicates the availability of the skills at each location (again considering that the utilization rate is 100%, other granular parameters might be provided). The availability also indicates the ability to hire resources if not available.

Location 1

UNIX/AIX—5 resources of normal expertise and 5 experts.

Storage—none

Location 2

UNIX/AIX—none

Storage—10 resources 5 of each type of expertise

Location 3

UNIX/AIX—3 resources of normal expertise and 2 experts.

Storage—5 expert resources and 3 of normal expertise

Given the above inputs, the algorithm used by the allocating means for creating at least one allocation plan. Consider the case of Storage administration, the final allocation plan output by the allocating means is as shown in Table 1:

TABLE 1

| | | Location 1 | Location 2 | Location 3 |
|---|---|---|---|---|
| UNIX/AIX administration | Normal | 3 | | 1 |
| | Expert | 1 | | 1 |
| Storage administration | Normal | | 1 | 1 |
| | Expert | | 1 | 1 |

The above plan is fed into the out means for testing to verify if it can address the predefined outage scenarios: An example outage is civil disturbances at Location1. Assume that all resources at Location1 are not able to perform their operations. Lets us examine if the allocation plans meet the resiliency requirements as outline by critical workload analyzer for storage administration.
1. Critical workload=80% of Sev1
2. 2 experts with 50% of their time+2 normal resources with 30% of time can address 100% of Sev1
3. 1 expert with 100% of time+1 normal resource with 30% of time can address 81% of Sev1. Thus the critical workload is addressed.

### Electronic Device Incorporating Skill Resiliency Planning

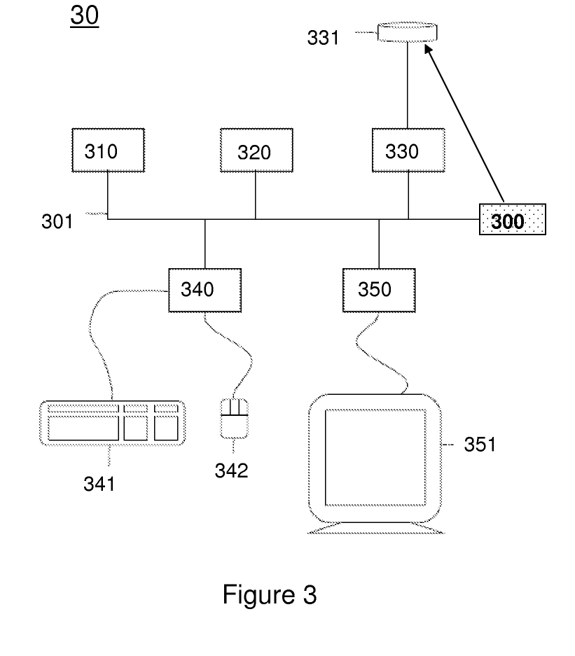

FIG. 3 schematically shows an embodiment of the system 30, wherein the system 30 can comprise a client, a server and/or a system for skill resiliency planning. It should be understood that FIG. 3 is only intended to depict the representative major components of the system 30 and that individual components may have greater complexity than that represented in FIG. 3. Several particular examples of such additional complexity or additional variations are disclosed herein; it being understood that these are by way of example only and are not necessarily the only such variations.

The system 30 comprises a system bus 301. A processor 310, a memory 320, a disk I/O adapter 330, a network interface (not shown in the Figure), a transceiver and a UI adapter 340 are operatively connected to the system bus 301. A disk storage device 331 is operatively coupled to the disk I/O adapter 330, in the case of the client this being an optional element. A keyboard 341, a mouse 342 (optional element) and a display 343 are operatively coupled to the UI adapter 340. A display device 351 is operatively coupled to the system bus 301 via a display adapter 350. The terminal/display interface 350 is used to directly connect one or more display units 351 to the computer system 30.

The system 30 is configured to implement skill resiliency system 300 coupled to the system bus and the storage medium, which for example can host the repository, and execute a set of instruction via a signal embodied in a carrier ware is stored on a tangible computer readable medium such as a disk storage device 331. The system 30 is configured to load the program into memory 320 and execute the program on the processor 310, on the client, the server and/or the gateway. The user inputs information to the system 30 using the keyboard 341 and/or the mouse 342. The system 30 outputs information to the display device 351 coupled via the display adapter 350. The skilled person will understand that there are numerous other embodiments of the workstation known in the art and that the present embodiment serves the purpose of illustrating the invention and must not be interpreted as limiting the invention to this particular embodiment.

The disk I/O adapter 330 coupled to the disk storage device 331, in turn, coupled to the system bus 301 and the disk storage devices represents one or more mass storage devices, such as a direct access storage device or a readable/writable optical disk drive. The disk I/O adapter 330 supports the attachment of one or more mass storage devices 331, which are typically rotating magnetic disk drive storage devices, although there could alternatively be other devices, including arrays of disk drives configured to appear as a single large storage device to a host and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), high density DVD (HDDVD), holography storage systems, blue laser disks, IBM Millipede devices and the like.

The network interfaces and the transceiver allow the system 30 to communicate with other computing systems over a communications medium, preferably over a network. The network may be any suitable network or combination of networks and may support any appropriate protocol suitable for communication of data and/or code to/from multiple computing systems. Accordingly, the network interfaces can be any device that facilitates such communication, regardless of whether the network connection is made using present day analog and/or digital techniques or via some networking mechanism of the future. Suitable communication media include, but are not limited to, networks implemented using one or more of the IEEE (Institute of Electrical and Electronics Engineers) 802.3×“Ethernet” specification; cellular transmission networks; and wireless networks implemented one of the IEEE 802.11x, IEEE 802.16, General Packet Radio Service (“GPRS”), FRS (Family Radio Service), or Bluetooth specifications. Those skilled in the art will appreciate that many different network and transport protocols can be used to implement the communication medium. The Transmission Control Protocol/Internet Protocol (“TCP/IP”) suite contains suitable network and transport protocols. In other embodiments, the computing systems 400 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

Although the invention has been described with reference to the embodiments described above, it will be evident that other embodiments may be alternatively used to achieve the same object. The scope of the invention is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. The invention can be implemented by means of hardware and software comprising several distinct elements.

1. A method for skill resiliency planning, wherein the method comprises:
receiving a request, wherein the request comprises definition of services;
creating at least one allocation plan based on at least one available resource, at least one resiliency option and the received request;
identifying an optimal allocation plan from the at least one allocation plan, wherein creating the at least one allocation plan comprises: analyzing the received request, creating a work schedule from the received request, and allocating at least one available resources to accomplish the work schedule, wherein analyzing the request and creating a work schedule comprises: creating at least one granular service from the received request prior to creating the work schedule, and determining a resiliency option for the at least one of the granular service,
wherein said method further comprises identifying at least one available resource from a repository,
wherein said method further comprises mapping the at least one available resource to an appropriate work schedule,
wherein said method further comprises determining an optimal resource form the at least one available resource identified to the appropriate work schedule,
wherein said method further comprises allocating the optimal resource to the appropriate work schedule,
wherein the resiliency options comprise a set of pre-defined rules,
wherein the resiliency options are dynamically computed based on the received request and previously stored data in the repository, and
wherein said method further comprises assigning the optimal allocation plan to a requesting entity.

2-21. (canceled)
